(19) United States
(12) Patent Application Publication
(10) Pub. No.: US 2009/0052070 A1
(43) Pub. Date: Feb. 26, 2009

(54) HEATABLE MIRROR

(75) Inventors: Alain Jardinet, Jumet (BE); Hugues Lefevre, Jumet (BE); Florent Scarso, Jumet (BE)

Correspondence Address: AKERMAN SENTERFITT, P.O. BOX 3188, WEST PALM BEACH, FL, 33402-3188, US

(73) Assignee: Glaverbel-Cntre R & D, Jumet (BE)

(21) Appl. No.: 11/817,334

(22) PCT Filed: Mar. 1, 2006
(86) PCT No.: PCT/EP2006/060348

§ 371 Date: Apr. 2, 2008

(30) Foreign Application Priority Data
Mar. 2, 2005 (EP) 05101614.5

(51) Int. Cl. G02B 5/08

(52) U.S. Cl. 359/838

(57) ABSTRACT

Electrically heatable mirror comprising a clear soda-lime glass sheet coated on one of its surface sides by a silver-based reflective layer and on the other surface side by an electrically conductive layer adapted to dissipate no more than (25) to (90) W/m².

This invention relates to a heatable mirror and, especially, to a heatable mirror comprising a glazing structure silver coated on one side and bearing an electrically conducting coating on the other side, as well as an anti-fog mirror comprising the same structure.

Known heatable mirrors comprise a conductive element, a metallic wire grid or an electrically conducting layer, deposited on the rear side of the mirrors, on top of a silver reflecting layer that may be protected by a paint coat. The conductive element may be heated by Joule effect generated by a flowing-through electrical current. A further isolating paint or layer generally protects the conductive element. Alternatively, heatable mirrors made of laminated structures of two or more glass sheets in which an internal electrically conductive layer is isolated from the outside are known as well. Such known heatable mirrors suffer from the disadvantage of heat inertia caused by the relatively poor heat conduction property of glass.

According to a first aspect, the invention provides an electrically heatable mirror as defined in claim 1.

According to a second aspect, the invention provides the anti-fog mirror bearing an electrically heatable layer on its exposed surface defined in claim 22.

Dependent claims define further preferred embodiments of the invention.

The present invention may provide one or more of the following advantages:
simpler and cheaper structure than with already known heatable mirrors, comprising only a single glass sheet, like in traditional mirrors;
lower voltage and electric power requirements for achieving the same heating effect;
safe behaviour, as with isolated conductive elements.

The heatable mirror according to the invention comprises a glazing structure that is based on a soda-lime glass sheet. By soda-lime glass sheet, it is meant a glass sheet of from 1.0 to 6.0 mm thick having the following composition, expressed in percentages by weight:

| | |
|---|---|
| SiO₂ | 60 to 75%, |
| Na₂O | 10 to 20%, |
| CaO | 0 to 16%, |
| K₂O | 0 to 10%, |
| MgO | 0 to 10%, |
| Al₂O₃ | 0 to 5%, |
| BaO | 0 to 2%, with both further conditions: |

alkaline-earth oxides (BaO+CaO+MgO) totalising from 10 to 20%,

alkaline oxides (Na₂O+K₂O) totalising from 10 to 20%.

Minor additives may as well be present in very small proportions in the glass, like colourants (Fe₂O₃, CoO, Nd₂O₃, . . . ), redox components (NaNO₃, Na₂SO₄, coke, . . . ) and the like.

Preferably, clear soda-lime glass sheets that are used for the mirror according to the invention exhibits a transmission coefficient Tv of visible light, measured under standard illuminant D65 (normalised by the C.I.E. “Commission Internationale de l'Eclairage” for representing an average daylight), observed within a 10° solid angle and for a glass thickness of 4 mm, of from 89.0 to 91.0%. More preferably, that clear glass sheet exhibits a neutral colour in transmission of light. Most preferable is the clear glass sheet that exhibits the following colour properties in light transmission, when measured under standard illuminant D65, observed within a 100 solid angle and for a glass thickness of 4 mm:
94.0<L*<95.0,
−1.5<a*<−0.3,
0.0<b*<0.5.

Colour is expressed here by means of the standard L*, a*, b* system of the C.I.E.

The mirror according to the invention is coated on one of its surface sides by a silver-based reflective layer. That layer is the same as the one encountered on mirrors of general use that can be found on the market. In cases where the glass has been produced by the so-called “float process”, the silver layer is preferably deposited on the side of the glass that has been in contact with the molten tin bath.

That silver-based reflective layer is top coated by at least one protection paint. Preferably, the paint is free of lead.

According to the invention, the glazing structure of the mirror is coated on its side opposite to the reflective layer by an electrically conductive layer adapted to dissipate no more than 25 to 90 W/m².

Other components may be present besides the glazing structure of the mirror according to the invention, like, for example, varnish or lacquer layers, transparent plastic sheets and other clear glass sheets of any type and composition. Preferably, the mirror according to the invention consists essentially of the glazing structure defined above, without any additional plastic or glass sheet. Most preferable mirror according to the invention consists only of the glazing structure defined above.

In a first preferred embodiment of the heatable mirror of the invention, the electrically conductive layer is an exposed layer in direct contact with the surrounding atmosphere.

In a second preferred embodiment of the heatable mirror of the invention, the heatable mirror shows a reflected light coefficient of from 85 to 93%, measured under standard illuminant D65, observed within a solid angle of 100 and for a mirror thickness of 4 mm.

In a third preferred embodiment of the heatable mirror of the invention, the electrically conductive layer is a pyrolitic layer which has been deposited on the glass surface at temperatures of from 500 to 750° C. Preferably, the conductive layer has been deposited at temperatures of from 570 to 660° C. That type of layer can be deposited directly on the hot glass ribbon, at the leave of the process section where the molten glass floats upon a tin bath in a so-called “float glass” well known process making of glass. Advantageously, the pyrolitic layer is a chemical vapour deposited (CVD) layer.

Generally, the nature of that pyrolitic layer is essentially of SnO₂ doped with F and/or Sb. A pyrolitic layer consisting essentially of SnO₂ doped with F has given excellent results. Thickness of that pyrolitic layer has to be carefully adapted in order to deliver a suitable surface resistivity. Thickness of the pyrolitic layer should advantageously be from 250 to 500 nm. A thickness of about 300 nm has given excellent results.

In a fourth preferred embodiment, the heatable mirror exhibits the following colour properties in light reflection, when measured under standard illuminant D65, observed within a 100 solid angle and for a thickness of the mirror of 4 mm:
91.0<L*<95.0,
−2.5<a*<−0.5,
4.0<b*<7.0.

Advantageously, the heatable mirror of that fourth embodiment has a colour purity P measured in reflection under standard illuminant D65, observed within a 10° solid angle and for a thickness of the mirror of 4 mm that is of from 1 to 7%. Preferably, that purity does not exceed 5%.

In a fifth preferred embodiment, the heatable mirror has a front face with a very low haze. In that mirror, haze of the glass sheet coated with the electrically conductive layer, measured in transmitted light, has an marked impact on diffuse reflectivity of the mirror, due to the fact that any incident light beam on a mirror surface crosses two times the coated glass of the mirror before reaching the eye of the observer. Consequently, diffuse reflectivity of a mirror surface is generally taken as a measure of its haze. A mirror that exhibits a diffuse reflective coefficient Rvd of from 0.1 to 1.5% is preferred. Most preferred is the mirror that exhibits a diffuse reflective coefficient Rvd of 0.1 to 0.6%. That diffuse reflective coefficient should be measured with a spectrophotometer equipped with a white integrating sphere. A Perkin-Elmer® 900 spectrophotometer has given excellent results. The mirror front face of which haze is to be measured is applied tangentially on the sphere so as to shut a small aperture in the sphere surface. An incident beam of monochromatic light delivered by the monochromator device of the spectrophotometer is targeted towards that sample, at a small angle from the perpendicular to its surface. An opposite aperture in the sphere located in the direction of the opposite angle past the perpendicular allows the escape of the direct every diffuse light beam reflected in whatever other direction. A light captor cell located elsewhere on the sphere surface measures the total diffused monochromatic light summed by the sphere within a 100 solid observation angle. The diffuse reflective coefficient Rvd is then computed by integrating all measured total diffused monochromatic lights over the visible spectrum wavelength range, as follows:

$$Rvd = \frac{{\sum }_{λ = 380}^{780 n m} Rvd ( λ ) * V ( λ ) * D 65 ( λ )}{{\sum }_{λ = 380}^{780 n m} V ( λ ) * D 65 ( λ )}$$

wherein,
Rvd(λ) is the spectral total diffuse light,
V(λ) is the spectral luminous efficiency of an average human eye
and D65(λ) is the relative spectral distribution of illuminant D65.

In a sixth preferred embodiment, the electrically conductive layer of the heatable mirror has a total surface roughness of from 20 to 40 nm and, preferably, of from 20.0 to 30.0 nm. By total surface roughness (Rₜ) it is meant the sum of the greatest height of the protrusions (Rₚᵣₒₜ) and the greatest depth of the pits (Rₚᵢₜ) measured with an atomic force microscope. The latter is delivering individual heights hᵢⱼ for each point of the surface according to 2 perpendicular directions i and j. Rₜ can be computed as follows:

Rₜ=Rₚᵣₒₜ+Rₚᵢₜ

wherein:

$${R}_{prot} = \vert {max}_{i , j} \{ {h}_{ij} - {h}_{moy} \} \vert$$

$${R}_{pit} = \vert {min}_{i , j} \{ {h}_{ij} - {h}_{moy} \} \vert$$

$${h}_{moy} = \frac{1}{N} {\sum }_{i} {\sum }_{j} {h}_{ij}$$

N being the number of measures.

Any method can be used to achieve said surface roughness, indifferently. Good results have been obtained with a float glass coated with an electrically conductive layer that has been mechanically polished with abrasives for a certain time up to the obtainment of the corrected surface roughness.

In a seventh preferred embodiment, the electrically conductive layer of the heatable mirror has a surface electrical resistivity of from 5 to 50Ω/□. Preferably, the surface electrical resistivity of the electrically conductive layer should be of from 5 to 20Ω/□. Most preferred is an electrically conductive layer having a surface electrical resistivity of from 13 to 17Ω/□.

In an eighth embodiment of the invention, an undercoat layer may be interposed between the electrically conductive layer and the glass surface. That interposed layer may as well be deposited on the glass surface by a pyrolitic coating process.

All eight embodiments described above may be combined, at least by pairs of any two of them. Even combined all eight together, the resulting mirror is still enabling.

A second aspect of the invention relates to an anti-fog mirror bearing an electrically heatable layer on its exposed surface side, wherein the layer is adapted for heating the exposed surface of the mirror by at least 2° C. above the surrounding atmosphere temperature. The aim is here to elevate the surface temperature slightly over the dew point of a warm and humid gas atmosphere whenever it leaches the mirror exposed surface in order to prevent, or at least to retard significantly, the formation of small drops of water fogging the mirror surface, so ruining its reflective properties.

Such an anti-fog mirror is realised by the application between two opposite border regions of the electrically heatable layer of an electric voltage of from 5 to 60 V. Preferably, that voltage is of from 20 to 30 V.

Advantageously, for not excessively heating the mirror, the electrically heatable layer is adapted to dissipate an electrical surface power of from 25 to 90 W/m². Adjustments of the applied voltage, the intrinsic surface resistivity of the layer and/or the thickness of the conductive layer have to be carefully tuned to the practical dimensions of the mirror for not exceeding a safe exposed surface temperature of 60° C. and, preferably, 50° C. and for keeping the electrical power in a range wherein the mirror is keeping its anti-fog properties.

The anti-fog mirror according to the invention is adapted to be used inside bathrooms when warm water vapour is being generated.

Mirrors according to the invention will now be described in details, by examples illustrating the invention, without seeking to limit the same.

### EXAMPLE 1

### Reference, Non-Compliant to the Invention

A commercial silver mirror (clear glass of 4 mm thick, silver coating of 60-110 μm thick, two layers of a lead-free alkyd based paint of 50 μm total 18-23° C. temperature). Moisture has then allowed to increase by generation of water vapour in the bathroom atmosphere. After less than 10 minutes, some water has started to condense on the mirror surface, forming a fog layer which prevented the normal reflective function of the mirror.

### EXAMPLE 2

### Compliant to the Invention

A mirror similar to the one of example 1 has been coated on its exposed surface with a pyrolitic hard layer made of an undercoat of SiOₓ oxides and a coat of F doped SnO₂ of total thickness around 400 nm showing a very low haze giving a 0.65% diffuse reflective coefficient and a surface electrical resistivity of 16Ω/□. The layer had previously undergone a mechanical polishing up to the obtainment of a total surface roughness of 24.6 nm. Two electrodes have then been put on the hard layer at a distance of 1.37 m from each other (mirror “A”). A second identical coated mirror (mirror “B”) has been prepared the same way as mirror A, except the distance between electrodes, which has been of 1.18 m.

Both mirrors were then placed in a bathroom atmosphere at 18-23° C. and water vapour was then generated up to reach 90% relative humidity.

An electrical power of 30 W/m² has been dissipated between the electrodes of mirror A and 40 W/m² between the electrodes of mirror B in order to heat their exposed surfaces.

If the electrical heating was switched on in permanence well before the generation of moisture in the room and the mirror had sufficient time to reach a temperature steady-state, no condensation appeared on the heated A mirror surface.

If the electrical heating was switched on just before the generation of moisture without allowing time for the mirror to reach equilibrium in surface temperature, there was again no fog appearance on mirror B heated surface.

In each case of those experiments, front mirror surface was kept at a temperature which was at least 2° C. higher than room temperature and just high enough to prevent water from condensing on the surface, i.e. higher than the dew point of water at the mirror surface temperature.

### EXAMPLE 3

### Compliant to the Invention

A similar heatable mirror as in example 2 has been prepared, except its surface resistivity which has been in this case of 25Ω/□, and the distance between its electrodes, which has been 1.5 m. The mirror has then been put in a very high moisture condition (100% relative humidity). By switching on an electric power of 25 W/m² through the mirror exposed surface layer, the fog appearance was delayed by more than 20 minutes, compared to an uncoated reference mirror of the same thickness, which was not heated.

1. An electrically heatable mirror comprising a glazing structure of a clear soda-lime glass sheet coated on one of its surface sides by a silver-based reflective layer and a topcoat paint layer protecting the silver layer, characterised in that the structure is coated on the other surface side by an electrically conductive layer adapted to dissipate no more than 25 to 90 W/m².

2. Mirror according to claim 1, characterised in that it consists essentially of a clear soda-lime glass sheet coated on one of its surface sides by a silver based reflective layer and a top coat paint layer protecting the silver layer, characterised in that the glass sheet is coated on the other surface side by an electrically conductive layer.

3. Mirror according to claim 1, characterised in that the electrically conductive layer is an exposed layer in direct contact with the surrounding atmosphere.

4. Mirror according to claim 1, characterised in that it shows a reflected light coefficient of from 85 to 93%, measured under standard illuminant D65, observed with a solid angle of 10° and for a mirror thickness of 4 mm.

5. Mirror according to claim 4, characterised in that it exhibits a reflected light coefficient of from 79 to 85%.

6. Mirror according to claim 1, characterised in that the electrically conductive layer is a hard chemically and mechanically resistant layer.

7. Mirror according to claim 6, characterised in that the hard electrically conductive layer is a pyrolitic layer deposited on the glass surface at temperatures of from 500 to 750° C.

8. Mirror according to claim 7, characterised in that the hard electrically conductive layer is a chemical vapour deposited (CVD) layer.

9. Mirror according to claim 8, characterised in that the hard electrically conductive layer consists essentially of a SnO₂ layer doped with F and/or Sb.

10. Mirror according to claim 6, characterised in that the electrically conductive layer has a thickness of from 250 to 500 nm n.

11. Mirror according to claim 1, characterised in that glass constituting the sheet coated with the electrically conductive layer exhibits a light transmission coefficient Tv, measured under standard illuminant D65, observed within a 10° solid angle and for a glass thickness of 4 mm of from 89.0 to 91.0%.

12. Mirror according to claim 1, characterised in that glass constituting the sheet coated with the electrically conductive layer exhibits a neutral colour in transmission of light.

13. Mirror according to claim 12, characterised in that glass constituting the sheet coated with the electrically conductive layer exhibits the following colour properties in light transmission, when measured under standard illuminant D65, observed within a 10° solid angle and for a glass thickness of 4 mm:
94.0<L*<95.0,
−1.5<a*<−0.3,
0.0<b*<0.5.

14. Mirror according to claim 1, characterised in that it exhibits the following colour properties in light reflection, when measured under standard illuminant D65, observed within a 10° solid angle and for a mirror thickness of 4 mm:
91.0<L*<95.0,
−2.5<a*<−0.5,
4.0<b*<7.0.

15. Mirror according to claim 14, characterised in that it has a colour purity of from 1 to 7%.

16. Mirror according to claim 1, characterised in that it has diffuse reflective coefficient (Rvd) observed within a 10° solid angle of from 0.1 to 1.5%.

17. Mirror according to claim 1, characterised in that the electrically conductive layer has a total surface roughness of from 20 to 40 nm.

18. Mirror according to claim 1, characterised in that the electrically conductive layer has a surface electrical resistivity of from 5 to 20Ω/□.

19. Mirror according to claim 1, characterised in that the electrically conductive layer has a surface electrical resistivity of from 13 to 17Ω/□.

20. Mirror according to claim 1, characterised in that an undercoat layer is interposed between the electrically conductive layer and the glass surface.

21. Mirror according to claim 1, characterised in that the electrically conductive layer is mechanically polished.

22. Anti-fog mirror bearing an electrically heatable layer on its exposed surface side, adapted for heating the exposed surface of the mirror by at least 2° C. above the surrounding atmosphere temperature by means of the application of an electrical voltage between two opposite border regions of the heatable layer that is of from 5 to 60 V and, preferably, of from 20 to 30 V.

23. Anti-fog mirror according to claim 22, characterised in that the electrically heatable layer is adapted to dissipate an electrical surface power of from 25 to 90 W/m².

24. Anti-fog mirror according to claim 22, characterised in that it is used in a bathroom.
